(19) United States
(12) Patent Application Publication
(10) Pub. No.: US 2026/0024940 A1
(43) Pub. Date: Jan. 22, 2026

(54) ELECTRICAL CONNECTOR AND ASSEMBLY

(71) Applicant: Lear Corporation, Southfield, MI (US)

(72) Inventor: Adi Peshkess, Canton, MI (US)

(73) Assignee: Lear Corporation, Southfield, MI (US)

(21) Appl. No.: 18/773,896

(22) Filed: Jul. 16, 2024

(51) Int. Cl. H01R 13/502

(52) U.S. Cl. CPC H01R 13/502

(57) ABSTRACT

An electrical connector, comprising: a first housing configured to at least partially receive a first terminal; a second housing configured to at least partially receive a second terminal and configured for coupling with the first housing; and a cover configured for connection with the second housing in a first configuration and a second configuration.

### TECHNICAL FIELD

The present disclosure generally relates to electrical connectors and electrical assemblies including electrical connectors, wires, and terminals.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is an exploded view generally illustrating an embodiment of an electrical assembly including an electrical connector with a cover aligned for connection in a first configuration according to teachings of the present disclosure.

FIG. 2 is an exploded view generally illustrating an embodiment of an electrical assembly including an electrical connector with a cover aligned for connection in a second configuration according to teachings of the present disclosure.

FIGS. 3 and 4 are partially exploded perspective views generally illustrating an embodiment of an electrical assembly including an electrical connector with a second housing and a cover connected in a first configuration according to teachings of the present disclosure.

FIGS. 5 and 6 are partially exploded views generally illustrating an embodiment of an electrical assembly including an electrical connector with a second housing and a cover connected in a second configuration according to teachings of the present disclosure.

FIG. 7 is a perspective view generally illustrating an assembled electrical assembly including an electrical connector with a second housing and a cover connected in a first configuration according to teachings of the present disclosure.

FIG. 8 is a perspective view generally illustrating an assembled electrical assembly including an electrical connector with a second housing and a cover connected in a first configuration according to teachings of the present disclosure.

FIGS. 9, 10, and 11 are a first perspective view, an enlarged partial a side view, and a second perspective view, respectively, generally illustrating an embodiment of a second housing according to teachings of the present disclosure.

FIGS. 12 and 13 are perspective views generally illustrating an embodiment of a cover according to teachings of the present disclosure.

FIG. 14 is a cross-sectional view generally illustrating portions of an embodiment a second housing and a cover connected in a first configuration according to teachings of the present disclosure.

FIG. 15 is a cross-sectional view generally illustrating portions of an embodiment a second housing and a cover connected in a second configuration according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

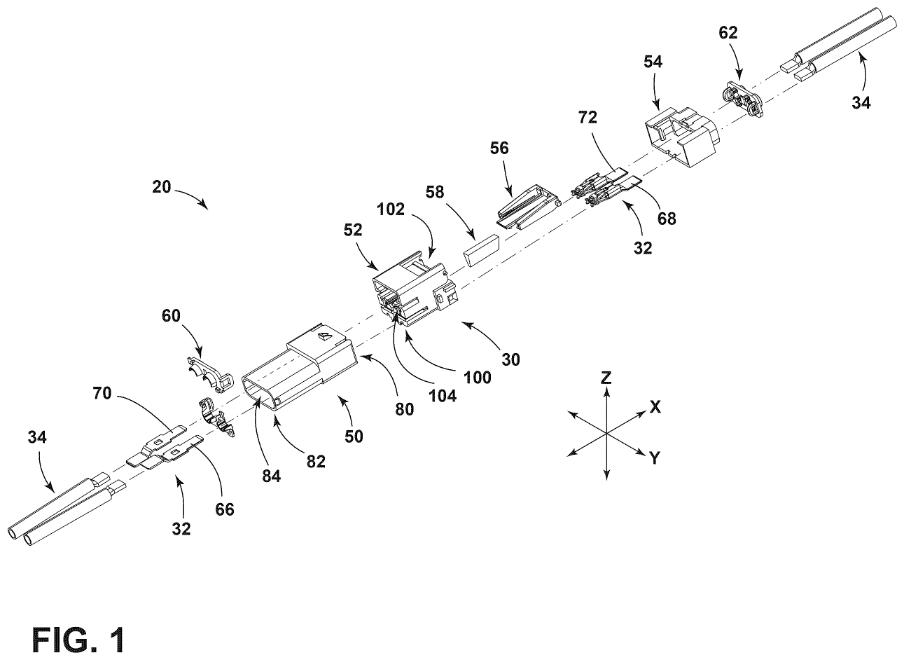

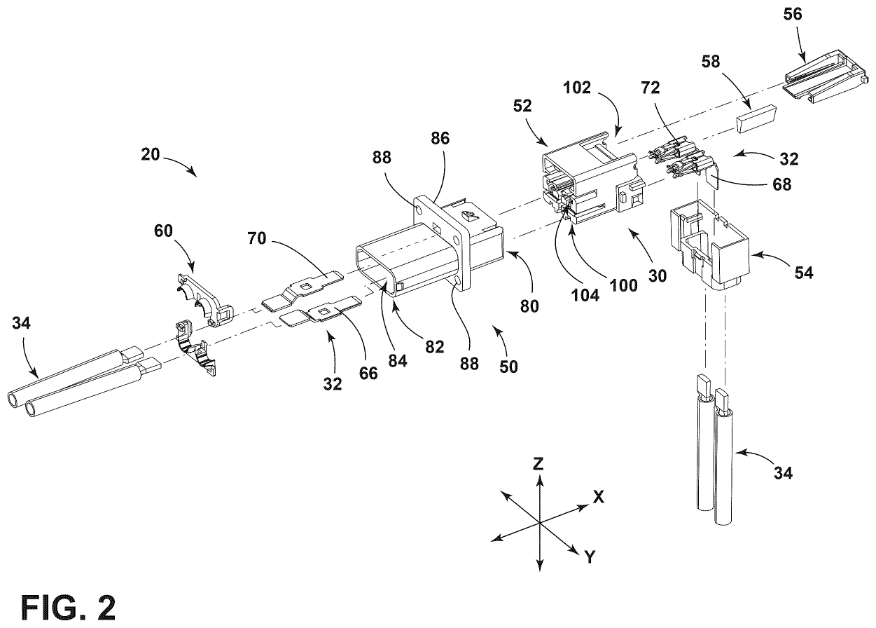

Referring to FIGS. 1 and 2, an electrical assembly 20 includes an electrical connector 30, a plurality of terminals 32, and a plurality of wires 34 coupled to the plurality of terminals 32. The electrical assembly 20 defines an X-direction, a Y-direction, and a Z-direction that are perpendicular to each other. The electrical connector 30 includes a first housing 50, a second housing 52, and a cover 54. The first housing 50 and the second housing 52 are configured for connection with each other in the X-direction (e.g., a connection direction). The second housing 52 and the cover 54 are configured for connection with each other. Optionally, the electrical connector 30 includes a first retainer 56, a second retainer 58, a first strain relief 60, and/or a second strain relief 62. The first retainer 56 is configured as a connector position assurance (CPA) device that ensures that the first housing 50 and the second housing 52 are properly connected. The second retainer 58 is configured as a terminal position assurance (TPA) device that ensures that one or more of the terminals 32 inserted into the second housing 52 are properly connected with the second housing 52. The second retainer 58 can be a single component or a plurality of separate components. The first strain relief 60 is connectable with the first housing 50 to limit strain on the one or more wires 34 connected thereto. The second strain relief 62 is connectable with the cover 54 to limit strain on the one or more wires 34 connected thereto.

The plurality of terminals 32 includes a first terminal 66, a second terminal 68, a third terminal 70, and a fourth terminal 72, but can include other numbers of terminals (e.g., two terminals, six terminals, other numbers). The first terminal 66 and the third terminal 70 are connected to respective wires of the plurality of wires 34 (e.g., first and third wires) and disposed at least partially in the first housing 50. The second terminal 68 and the fourth terminal 72 are connected to respective wires of the plurality of wires 34 (e.g., second and fourth wires) and are disposed at least partially in the second housing 52. The terminals connected to the first housing 50 (e.g., the first and third terminals 66, 70) and the terminals connected to the second housing 52 include corresponding mating configurations. For example, a portion of the first and third terminals 66, 70 is configured for insertion into a corresponding portion of the second and fourth terminals 68, 72 to electrically connect each pair of terminals 32.

The first housing 50 and the second housing 52 are configured for coupling with each other in the X-direction (e.g., the connection direction) to electrically connect one or more pairs of the plurality of terminals 32 and the plurality of wires 34 connected thereto. The cover 54 is configured for connection with the second housing 52 in a first configuration (FIG. 1) and in a second configuration (FIG. 2). The first configuration is a straight configuration in which the cover 54 is connected to the second housing 52 in the X-direction (e.g., the connection direction of the first and second housings 50, 52). The first configuration is used, for example, with terminals of the plurality of terminals 32 that are straight terminals extending parallel to the X-direction and/or with wires of the plurality of wires 34 having at least some portions extending parallel to the X-direction. The second configuration is a right-angle connection in which the cover 54 is connected to the second housing 52 in the Z-direction. The second configuration is used, for example, with terminals of the plurality of terminals 32 that are right-angle terminals that include portions extending parallel to the X-direction and portions extending parallel to the Z-direction (e.g., perpendicular to the X-direction), and/or with wires of the plurality of wires 34 having at least some portions extending parallel to the Z-direction. For example, the same second housing 52 and the same cover 54 can be utilized to provide a straight connection or a right-angle connection, which can allow the electrical connector 30 to be utilized in a wider range of environments than other connectors, and/or can reduce the number of different types of connectors utilized for a particular application (e.g., a vehicle, a machine, electrical equipment, among others).

The first housing 50 includes a front 80, a rear 82, and one or more terminal channels 84. A respective terminal of the plurality of terminals 32 (e.g., the first and third terminals 66, 70) is disposed at least partially in some or each of the one or more terminal channels 84. The first and third terminals 66, 70 are insertable from the rear 82 in the X-direction into the one or more terminal channels 84 toward, to, or beyond the front 80. The front 80 is configured to engage the second housing 52. Optionally, as illustrated in FIG. 2, the first housing 50 includes a mounting flange 86 that extends outward perpendicular to the X-direction and is configured to mount the electrical connector 30 to an external component. For example, the mounting flange 86 includes one or more mounting apertures 88 (e.g., through apertures).

The second housing 52 includes a front 100, a rear 102, and one or more terminal channels 104. A respective terminal of the plurality of terminals 32 (e.g., the second and fourth terminals 68, 72) is disposed at least partially in some or each of the one or more terminal channels 104. The second and fourth terminals 68, 72 are insertable from the rear 102 in the X-direction into the one or more terminal channels 104 toward, to, or beyond the front 100. The front 100 is configured to engage the first housing 50. For example, the front 100 is configured for at least partial insertion into the front 80 to couple (e.g., mechanically, releasably) the first housing 50 with the second housing 52.

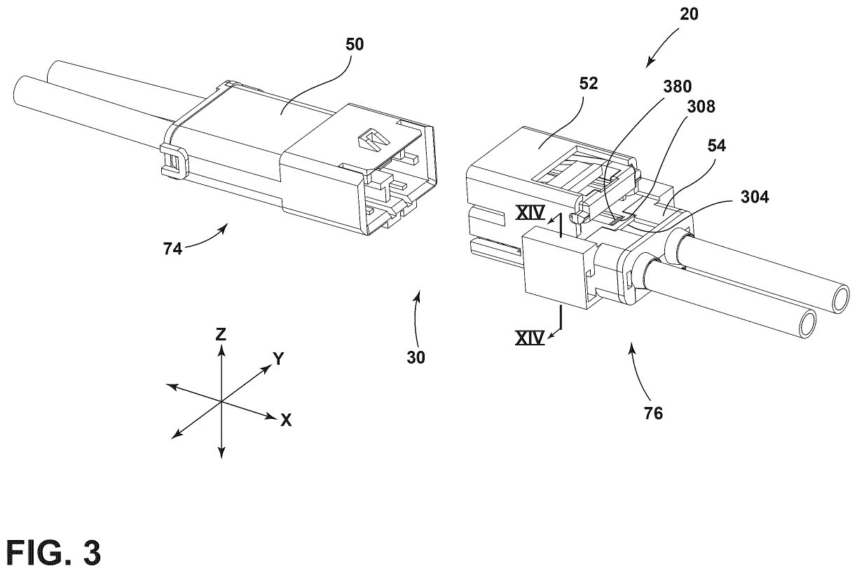

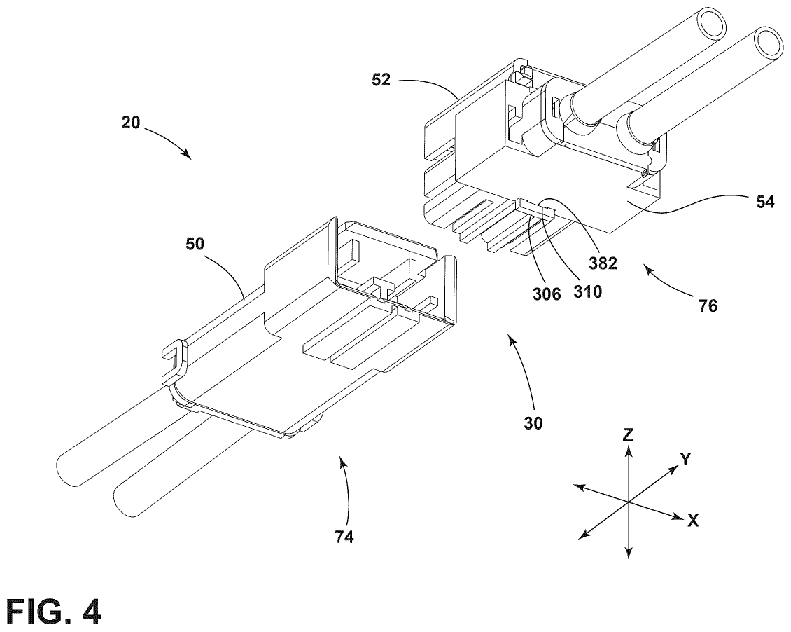

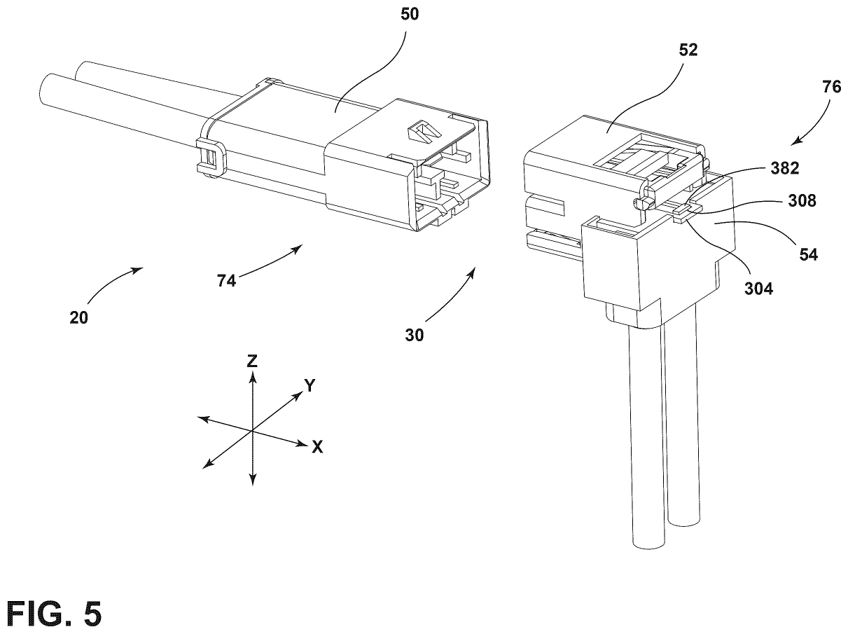

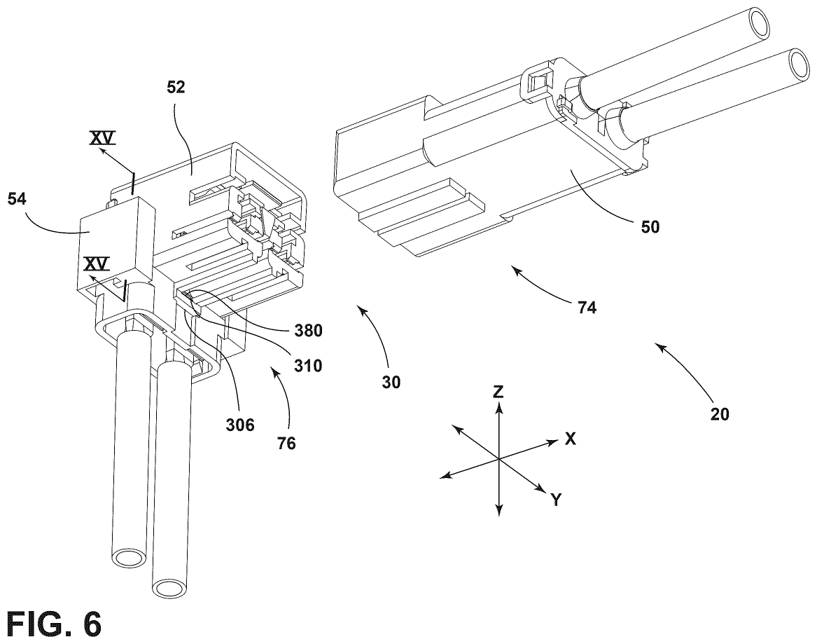

The first housing 50, the first and third terminals 66, 70, the wires 34 coupled to the first and third terminals 66, 70, and/or the first strain relief 60 are connected to form a first housing assembly 74 (FIGS. 3-6). The second housing 52, the cover 54, the first retainer 56, the second retainer 58, the second and fourth terminals 68, 72, the wires 34 coupled to the second and fourth terminals 68, 72, and/or the second strain relief 62 are connectable to form a second housing assembly 76 (FIGS. 3-6). The second housing assembly 76 is illustrated in FIGS. 3 and 4 with the second housing 52 and the cover 54 in the first configuration. The second housing assembly 76 is illustrated in FIGS. 5 and 6 with the second housing 52 and the cover 54 in the second configuration. In the first configuration, the cover 54 is disposed in a first orientation. In the second configuration, the cover 54 is disposed in a second orientation. The second orientation is rotated 180 degrees about a first axis and 90 degrees about a second axis relative to the first orientation. The first axis is perpendicular to the second axis. For example, the first axis is parallel to one of the X-direction or the Z-direction and the second axis is parallel to the other of the X-direction or the Z-direction.

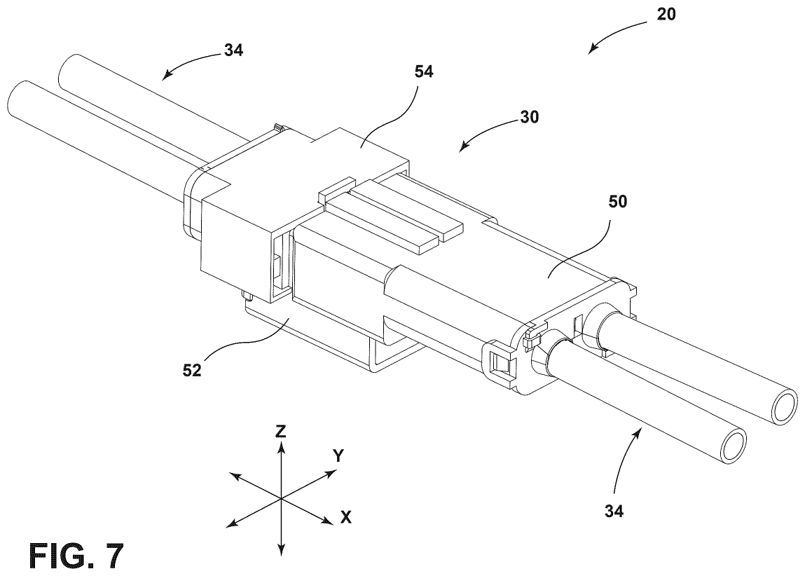

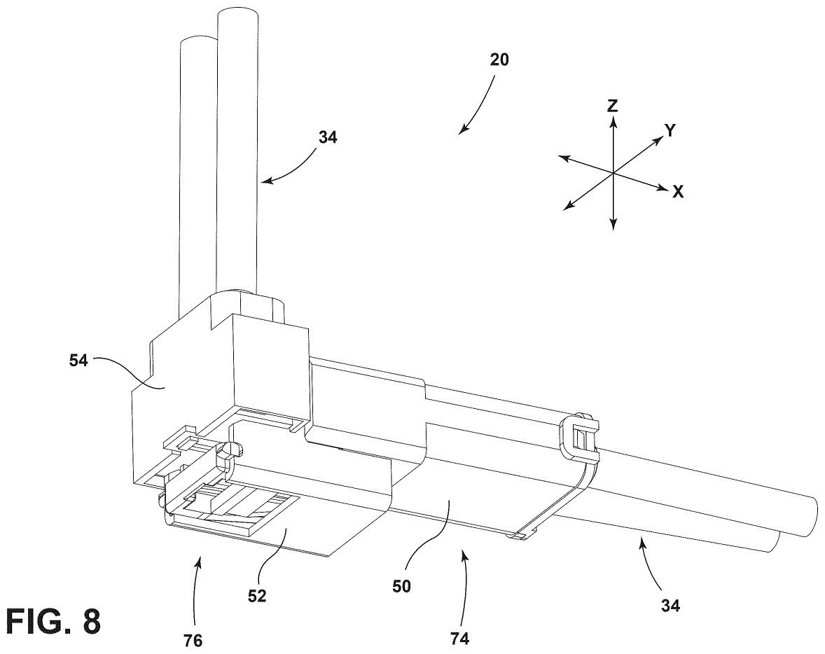

Referring to FIGS. 7 and 8, the first housing 50 and the second housing 52 are configured to be coupled together to provide an assembled configuration of the electrical connector 30. Optionally, coupling the first housing 50 with the second housing 52 includes coupling the first housing assembly 74 with the second housing assembly 76. In the assembled configuration, the second housing 52 is disposed at least partially in the first housing 50 and, optionally, the first retainer 56 is engaged with the first housing 50 and the second housing 52 to restrict and/or prevent movement therebetween. In the assembled configuration, each of the plurality of terminals 32 (FIGS. 1 and 2) is electrically connected another one of the plurality of terminals 32. For example, referring to the plurality of terminals 32 of FIGS. 1 and 2, the first terminal 66 is electrically connected with the second terminal 68, and the third terminal 70 is electrically connected to the fourth terminal 72. With the second housing 52 and the cover 54 connected in the first configuration, such as illustrated in FIG. 7, the second and fourth terminals 68, 72 have straight configurations (FIG. 1) parallel with the connection direction, and at least portions of the wires 34 connected to the second and fourth terminals 68, 72 (e.g., second and fourth wires) extend parallel to the X-direction (e.g., the connection direction). With the second housing 52 and the cover 54 connected in the second configuration, such as illustrated in FIG. 8, the second and fourth terminals 68, 72 have right-angle configurations (FIG. 2) and at least portions of the wires 34 connected to the second and fourth terminals 68, 72 (e.g., second and fourth wires) extend perpendicular to the X-direction (e.g., the connection direction). In the first and second configurations, the second and fourth terminals 68, 72 and/or the wires 34 connected thereto are disposed partially in the cover 54.

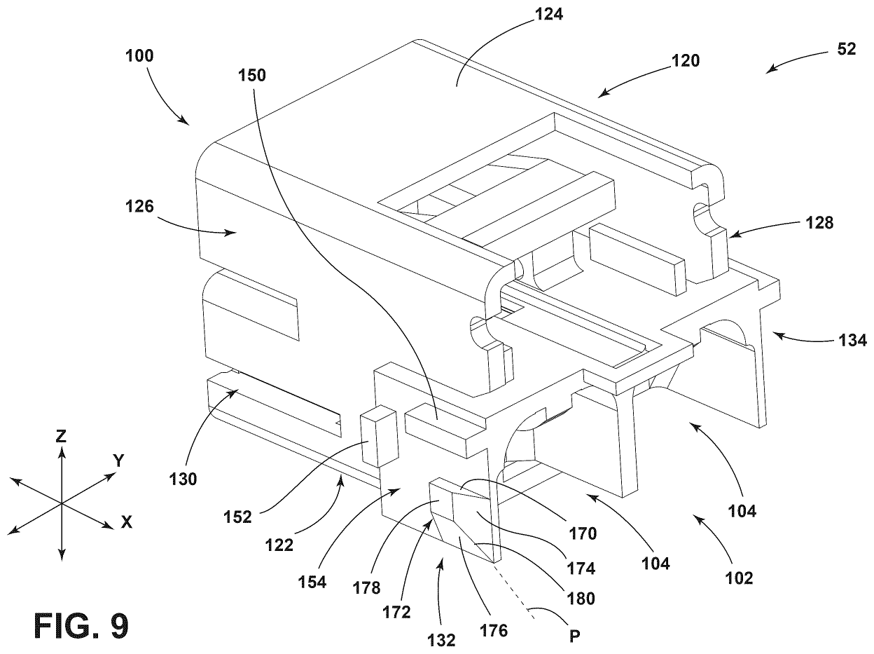

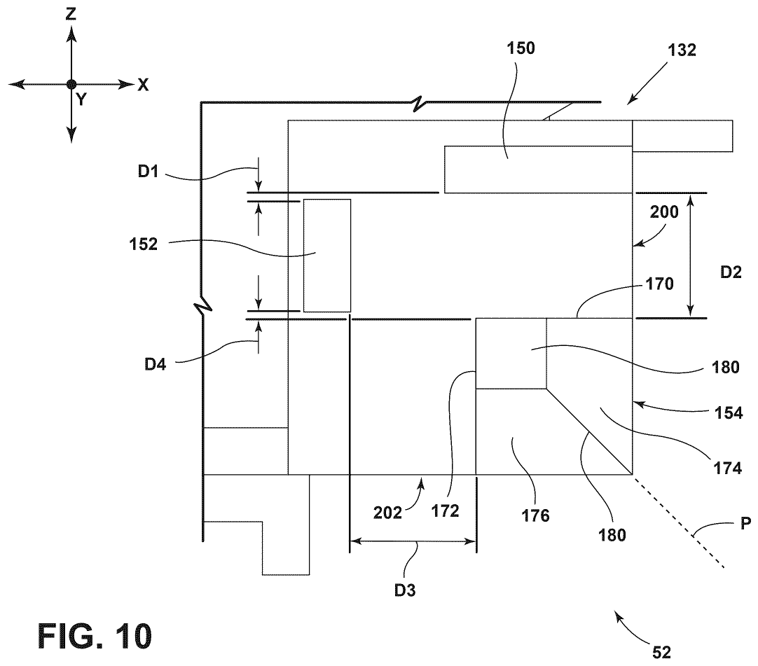

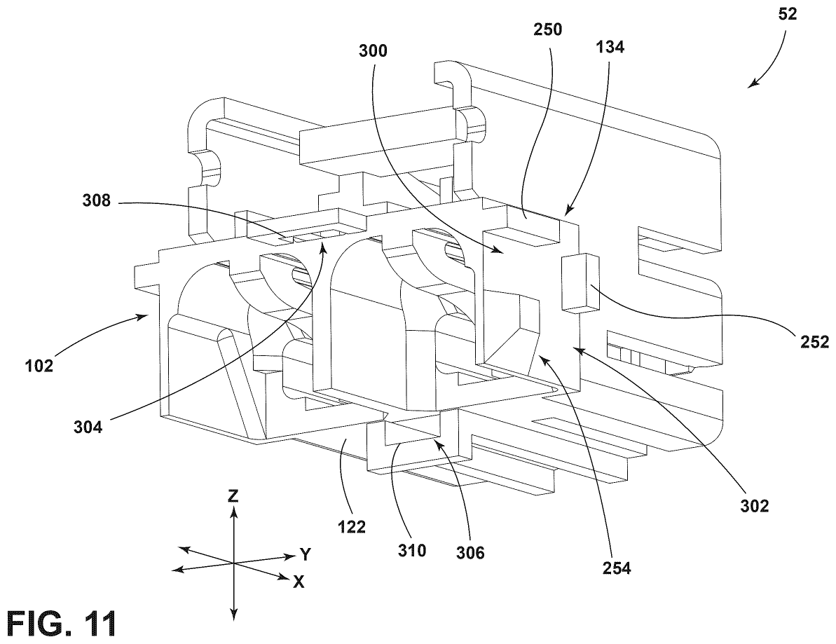

Referring to FIGS. 9-11, the second housing 52 is illustrated. The second housing 52 includes the front 100, the rear 102, the one or more terminal channels 104, a plurality of sides 120, one or more alignment formations 130, a first engagement structure 132 (FIGS. 9 and 10), and/or a second engagement structure 134 (FIG. 11). The plurality of sides 120 extend between the front 100 to the rear 102, and include a first side 122, a second side 124, a third side 126, and a fourth side 128. Optionally, the first side 122 and the second side 124 are bottom and top sides, respectively. The one or more alignment formations 130 are configured to engage corresponding formations of the first housing 50 (FIG. 1) to ensure proper alignment between the first housing 50 and the second housing 52. Referring to FIG. 9, the first engagement structure 132 is disposed at the third side 126, and the second engagement structure 134 is disposed at the fourth side 128. The first engagement structure 132 comprises a first plurality of protrusions extending outward from the third side 126 in the Y-direction. The first plurality of protrusions includes a first protrusion 150, a second protrusion 152, and a third protrusion 154. The first protrusion 150 comprises a first rib that is parallel to the X-direction (e.g., the connection direction). The second protrusion 152 comprises a second rib that is parallel to the Z-direction and perpendicular to the first protrusion 150. The third protrusion 154 comprises a ramp including a first pair of faces 170, 172, a second pair of faces 174, 176, and an outer face 178. The first pair of faces 170, 172 are perpendicular to the third side 126 and perpendicular to each other. For example, the face 170 is parallel to an X-Y plane and the face 172 is parallel to a Y-Z plane. The first pair of faces 170, 172 are trapezoidal faces. The second pair of faces 174, 176 are ramped faces (e.g., ramped trapezoidal faces). For example, the face 174 is parallel to the Z-direction, and disposed at oblique angles relative to the X-direction and the Y-direction, and the face 176 is parallel to the X-direction and disposed at oblique angles in the Y-direction and the Z-direction. Optionally, the first pair of faces 170, 172 and the second pair of faces 174, 176 are right trapezoids. The outer face 178 is spaced from and parallel to the third side 126. The first pair of faces 170, 172 and the second pair of faces 174, 176 extend from the third side 126 to the outer face 178 such that the third protrusion 154 forms a portion of a pyramid (e.g., a pyramidal frustum). The outer face 178 is rectangular, and can be square. A perimeter of the third protrusion 154, viewed from the Y-direction, is rectangular and can be square. The rectangle of the perimeter of the third protrusion 154 is larger than the rectangle of the outer face 178. The third protrusion 154 is symmetrical about a plane P that extends through an intersection 180 of the faces 174, 176. Optionally, the plane P is parallel with the Y-direction and is disposed at 45-degree angles relative to the X-direction and the Z-direction. Optionally, the face 174 extends from a rear edge of the third side 126 at which the third side 126 intersects with the rear 82 of the second housing 52. Optionally, the face 176 extends from a bottom edge of the third side 126 at which the third side 126 intersects with the first side 122 of the second housing 52.

Referring to FIG. 10, the first protrusion 150, the second protrusion 152, and the third protrusion 154 are offset from each other. The first protrusion 150 is spaced in the Z-direction from (e.g., above in FIG. 10) the second protrusion 152 and the third protrusion 154. For example, the first protrusion 150 and the second protrusion 152 are offset in the Z-direction by a first distance D1, and the first protrusion 150 and the third protrusion 154 are offset in the Z-direction by a second distance D2 to define a first slot 200. The first protrusion 150 and the third protrusion 154 are at least partially aligned in the X-direction such that the first protrusion 150 and the third protrusion 154 overlap when viewed in the Z-direction. The second protrusion 152 and the third protrusion 154 are offset in the X-direction by a third distance D3 to define a second slot 202, and are offset in the Z-direction by a fourth distance D4. For example, the second protrusion 152 and the third protrusion 154 do not overlap when viewed along the X-direction or the Z-direction. Additionally or alternatively, the first protrusion 150, the second protrusion 152, and the third protrusion 154 do not overlap when viewed along the X-direction (e.g., the connection direction). In some other examples, the first protrusion 150, the second protrusion 152, and the third protrusion 154 can be disposed not to overlap when viewed along other directions, such as the Y-direction or the Z-direction. The lack of overlap can be in the direction normal to a plane of mold separation of the mold utilized to form the second housing 52. Disposing the first protrusion 150, the second protrusion 152, and the third protrusion 154 to not overlap when viewed along the X-direction may allow for the least complex mold configuration. The first and fourth distances D1, D4 can facilitate manufacturing of the first engagement structure 132, such as by allowing molding (e.g., injection molding) without side action or undercutting. A ratio of the second distance D2 or the third distance D3 to the first distance D1 or the fourth distance D4 can, for example, be at least 10. The second and third distances D2, D3 are substantially the same (e.g., within manufacturing tolerances) such that the first and second slots 200, 202 have substantially the same widths. The first and second slots 200, 202 are configured to receive portions of the cover 54 (FIG. 8).

Referring to FIG. 11, the second engagement structure 134 of the second housing 52 is illustrated. The second engagement structure 134 includes a mirrored configuration of the first engagement structure 132 (FIGS. 9 and 10). For example, the second engagement structure 134 includes a fourth protrusion 250, a fifth protrusion 252, and a sixth protrusion 254 configured in the same or a similar manner as the first protrusion 150, the second protrusion 152, and the third protrusion 154, respectively. The fourth protrusion 250 and the sixth protrusion 254 at least partially define a third slot 300. The fifth protrusion 252 and the sixth protrusion 254 at least partially define a fourth slot 302. The third slot 300 and the fourth slot 302 are configured to receive portions of the cover 54 (FIG. 8).

The second housing 52 includes a first retaining tab 304 and a second retaining tab 306. The first retaining tab extends rearward in the X-direction from the rear 102 of the second housing 52. The first retaining tab 304 includes a first tab aperture 308 that extends through the first retaining tab 304 in the Z-direction. The second retaining tab 306 extends away from the first side 122 in the Z-direction. The second retaining tab 306 includes a second tab aperture 310 that extends through the second retaining tab 306 in the X-direction.

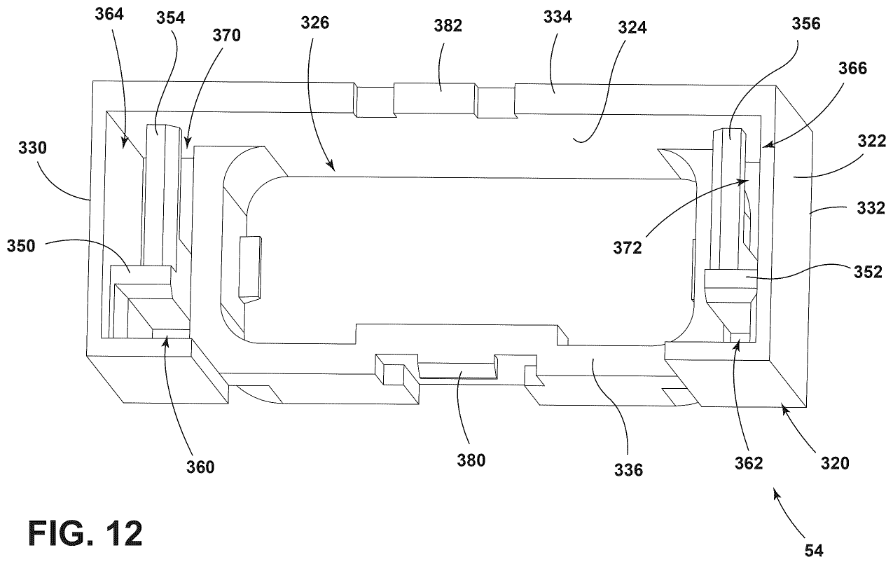

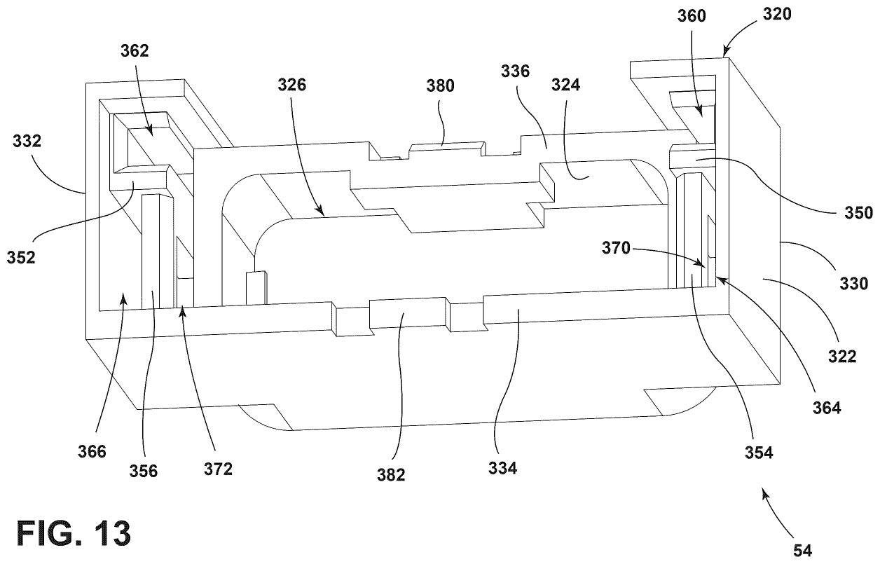

Referring to FIGS. 12 and 13, the cover 54 is illustrated. The cover 54 includes a peripheral wall 320 that includes an outer surface 322 and an inner surface 324. The inner surface 324 at least partially defines an aperture 326 (e.g., a through aperture). The aperture 326 is configured to receive portions of one or more of the plurality of terminals 32 (e.g., the second and fourth terminals 68, 72 of FIG. 1) and/or one or more of the wires 34 (FIG. 1) connected thereto. The peripheral wall 320 includes a first outer wall 330, a second outer wall 332 opposite the first outer wall 330, a third outer wall 334, and a fourth outer wall 336 opposite the third outer wall 334. The third and fourth outer walls 334, 336 are perpendicular to and connect the first and second outer walls 330, 332 such that the peripheral wall 320 includes a rectangular configuration. The inner surface 324 is parallel with the X-direction in the first configuration of the second housing 52 and the cover 54, and is perpendicular to the X-direction in the second configuration of the cover 54. In the first configuration, the inner surface 324 (e.g., at the third outer wall 334) is in contact with the first side 122 of the second housing 52 (FIG. 4). In the second configuration, the inner surface 324 (e.g., at the third outer wall 334) is in contact with the rear 102 of the second housing 52 (FIG. 5).

The cover 54 includes a first inner wall 350 extending from the inner surface 324 of the peripheral wall 320 (e.g., from the first outer wall 330), a second inner wall 352 extending from the inner surface 324 (e.g., from the second outer wall 332), a third inner wall 354 extending from the inner surface 324 (e.g., from the third outer wall 334), and/or a fourth inner wall 356 extending from the inner surface 324 (e.g., from the third outer wall 334). The first inner wall 350 is parallel to and spaced from the fourth outer wall 336 such that the first outer wall 330, the fourth outer wall 336, and the first inner wall 350 at least partially define a first channel 360. The second inner wall 352 is parallel to and spaced from the fourth outer wall 336 such that the second outer wall 332, the fourth outer wall 336, and the second inner wall 352 cooperate to at least partially define a second channel 362. The first and second channels 360, 362 are configured to at least partially receive the first and fourth protrusions 150, 250 (FIGS. 9 and 11) with the cover 54 in the first configuration and configured to at least partially receive the second and fifth protrusions 152, 252 (FIGS. 9 and 11) with the cover 54 in the second configuration. For example, the spacing of the first inner wall 350 and the second inner wall 352 from the fourth outer wall 336 corresponds to (e.g., is at least a large as) a thickness of the first protrusion 150 (e.g., measured in the Z-direction in FIG. 9), a thickness of the second protrusion 152 (e.g., measured in the X-direction in FIG. 9), a thickness of the fourth protrusion 250 (e.g., measured in the Z-direction in FIG. 11), and/or a thickness of the fifth protrusion 252 (e.g., measured in the X-direction in FIG. 11). The second and third distances D2, D3 (FIG. 10) correspond to the thickness of the first and second inner walls 350, 352.

The third inner wall 354 is parallel to and spaced from the first outer wall 330, and extends between the third outer wall 334 and the first inner wall 350 such that the first outer wall 330, the third outer wall 334, the first inner wall 350, and the third inner wall 354 at least partially define a third channel 364. The fourth inner wall 356 is parallel to and spaced from the second outer wall 332, and extends between the third outer wall 334 and the second inner wall 352 such that the second outer wall 332, the third outer wall 334, the second inner wall 352, and the fourth inner wall 356 at least partially define a fourth channel 366. The third inner wall 354 includes a third inner wall recess or aperture 370 configured to receive a portion of the third protrusion 154 (FIG. 9) with the cover 54 in the first configuration and configured to receive a portion of the sixth protrusion 254 (FIG. 11) with the cover 54 in the second configuration. The fourth inner wall 356 includes a fourth inner wall recess or aperture 372 configured to receive the portion of the sixth protrusion 254 (FIG. 11) with the cover 54 in the first configuration and configured to receive the portion of the third protrusion 154 (FIG. 9) with the cover 54 in the second configuration. For example, the third and fourth inner walls 354, 356 are configured to engage (e.g., latch) onto the third and sixth protrusions 154, 254 to latch/lock the cover 54 with the second housing 52.

The cover 54 includes a first projection 380 that extends outward from and perpendicular to the fourth outer wall 336. The cover 54 includes a second projection 382 that extends forward from and parallel to the third outer wall 334. In the first configuration, the first projection 380 extends into the first tab aperture 308 of the first retaining tab 304 (FIG. 3), which latches the cover 54 with the second housing 52, and the second projection 382 extends into the second tab aperture 310 of the second retaining tab 306 (FIG. 4). In the second configuration, the second projection 382 extends into the first tab aperture 308 of the first retaining tab 304 (FIG. 5), and the first projection 380 extends into the second tab aperture 310 of the second retaining tab 306 (FIG. 6), which latches the cover 54 with the second housing 52. Optionally, the cover 54 includes the first retaining tab 304 and/or the second retaining tab 306, and the second housing 52 includes the first projection 380 and/or the second projection 382. Optionally, the second housing 52 does not include the first and second retaining tabs 304, 306, the cover 54 does not include the first and second projections 380, 382, and the second housing 52 and the cover 54 are connected (e.g., latched, locked, among others) exclusively via the first engagement structure 132 and/or the second engagement structure 134.

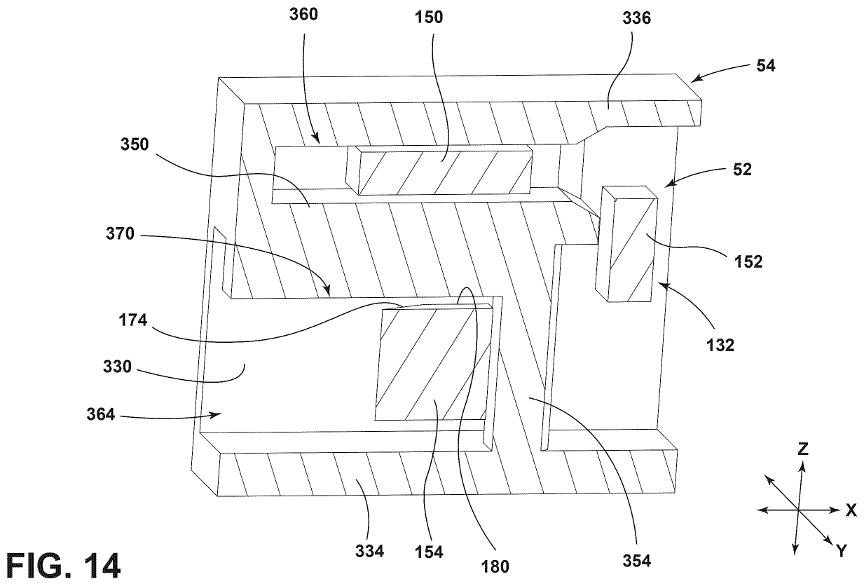

Referring to FIG. 14, a partial cross-sectional view of the cover 54 connected to the second housing 52 in the first configuration illustrates the cover 54 engaged with the first engagement structure 132. The first protrusion 150 is disposed at least partially in and/or engaged with the first channel 360, limiting and/or preventing relative movement between the second housing 52 and the cover 54 in the Z-direction (e.g., up and down in FIG. 14). The third protrusion 154 is disposed in and/or engaged with the third channel 364, limiting and/or preventing relative movement of the second housing 52 and the cover 54 away from each other in the X-direction. For example, in the first configuration, the cover 54 is configured to engage the first protrusion 150 and the third protrusion 154. Optionally, the first inner wall 350 is in contact with a side of the second protrusion 152, limiting relative movement of the second housing 52 and the cover 54 toward each other in the X-direction (e.g., limiting an insertion depth).

With the cover 54 in the first configuration, the cover 54 is also engaged with the second engagement structure 134 (FIG. 11) in a corresponding manner. For example, the fourth protrusion 250 is disposed at least partially in and/or engaged with the second channel 362, limiting and/or preventing relative movement between the second housing 52 and the cover 54 in the Z-direction. The sixth protrusion 254 is disposed in and/or engaged with the fourth channel 366, limiting and/or preventing relative movement of the second housing 52 and the cover 54 away from each other in the X-direction. Optionally, the second inner wall 352 is in contact with a side of the fifth protrusion 252, limiting relative movement of the second housing 52 and the cover 54 toward each other in the X-direction (e.g., limiting an insertion depth).

Connecting the cover 54 with the second housing 52 in the first configuration includes sliding the cover 54 onto the second housing 52 such that the first protrusion 150 slides into the first channel 360 and such that the third protrusion 154 slides into the third channel 364. Sliding the third protrusion 154 into the third channel 364 includes sliding a portion of the third inner wall 354 along the face 174 (e.g., a ramped face) such that at least one of the second housing 52 or the cover 54 deflect (e.g., elastically) in the Y-direction. The sliding continues with the third inner wall 354 sliding along the outer face 178 until the outer face 178 is aligned with the third inner wall recess or aperture 370, which allows the at least one of the second housing 52 or the cover 54 to deflect back in the Y-direction such that the third protrusion 154 is disposed at least partially in the third inner wall recess or aperture 370. For example, the third protrusion 154 snaps into the third inner wall recess or aperture 370 to lock the cover 54 with the second housing 52. With the third protrusion 154 disposed at least partially in the third inner wall recess or aperture 370, the second housing 52 and the cover 54 are latched/locked together. A corresponding sliding movement occurs between the second engagement structure 134 and the cover 54. For example, the fourth protrusion 250 slides into the second channel 362, and the fourth inner wall 356 slides along a ramped face and then an outer face of the sixth protrusion 254 until the sixth protrusion 254 is disposed at least partially in the fourth inner wall recess or aperture 372.

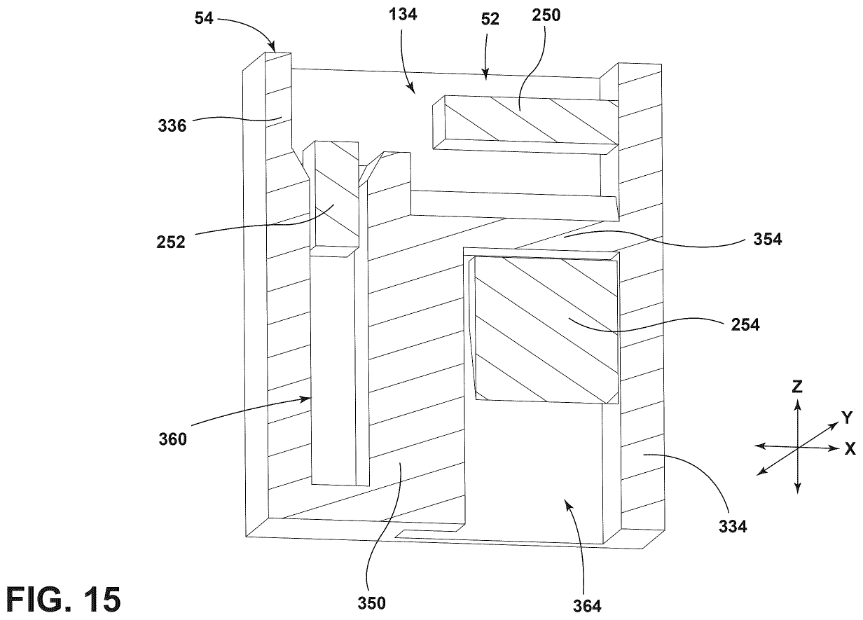

Referring to FIG. 15, a partial cross-sectional view of the cover 54 connected to the second housing 52 in the second configuration and illustrates the cover 54 engaged with the second engagement structure 134. The fifth protrusion 252 is disposed at least partially in and/or engaged with the first channel 360, limiting and/or preventing relative movement between the second housing 52 and the cover 54 in the X-direction (e.g., left and right in FIG. 14). The sixth protrusion 254 is disposed in and/or engaged with the third channel 364, limiting and/or preventing relative movement of the second housing 52 and the cover 54 away from each other in the Z-direction.

With the cover 54 in the second configuration, the cover 54 is also engaged with the first engagement structure 132 (FIG. 9) in a corresponding manner. For example, the second protrusion 152 is disposed at least partially in and/or engaged with the second channel 362, limiting and/or preventing relative movement between the second housing 52 and the cover 54 in the X-direction. The third protrusion 154 is disposed in and/or engaged with the fourth channel 366, limiting and/or preventing relative movement of the second housing 52 and the cover 54 away from each other in the Z-direction. For example, in the second configuration, the cover 54 is configured to engage the second protrusion 152 and the third protrusion 154.

Connecting the cover 54 with the second housing 52 in the second configuration includes sliding the cover 54 onto the second housing 52 such that the fourth protrusion 250 slides into the second channel 362 and such that the sixth protrusion 254 slides into the third channel 364. Sliding the sixth protrusion 254 into the third channel 364 includes sliding a portion of the third inner wall 354 along a ramped face of the sixth protrusion 254 such that at least one of the second housing 52 or the cover 54 deflect (e.g., elastically) in the Y-direction. The sliding continues with the third inner wall 354 sliding along an outer face of the sixth protrusion 254 until the outer face is aligned with the third inner wall recess or aperture 370, which allows the at least one of the second housing 52 or the cover 54 to deflect back in the Y-direction such that the sixth protrusion 254 is disposed at least partially in the fourth inner wall recess or aperture 372. With the sixth protrusion 254 disposed at least partially in the third inner wall recess or aperture 370, the second housing 52 and the cover 54 are latched/locked together. A corresponding sliding movement occurs between the first engagement structure 132 and the cover 54. For example, the first protrusion 150 slides into the second channel 362, and the fourth inner wall 356 slides along the face 176 (e.g., a ramped face) and then the outer face 178 of the third protrusion 154 until the third protrusion 154 is disposed at least partially in the fourth inner wall recess or aperture 372.

The instant disclosure includes the following non-limiting embodiments:

An electrical connector, comprising: a first housing configured to at least partially receive a first terminal; a second housing configured to at least partially receive a second terminal and configured for coupling with the first housing; and a cover configured for connection with the second housing in a first configuration and a second configuration.

The electrical connector of any preceding embodiment, wherein the first configuration is a straight configuration, and the second configuration is a right-angle configuration.

The electrical connector of any preceding embodiment, wherein the second housing includes an engagement structure comprising a first protrusion, a second protrusion, and a third protrusion extending from a side of the second housing.

The electrical connector of any preceding embodiment, wherein the cover is configured to engage the first protrusion and the third protrusion in the first configuration and to engage the second protrusion and the third protrusion in the second configuration.

The electrical connector of any preceding embodiment, wherein the first protrusion comprises a first rib that is parallel to a connection direction; the second protrusion comprises a second rib that is perpendicular to the first rib; and the third protrusion comprises a ramp.

The electrical connector of any preceding embodiment, wherein the ramp comprises a pair of trapezoidal perpendicular faces and a pair of trapezoidal ramped faces.

The electrical connector of any preceding embodiment, wherein the first protrusion, the second protrusion, and the third protrusion are spaced from each other such that the first protrusion, the second protrusion, and the third protrusion do not overlap in a connection direction of the electrical connector.

The electrical connector of any preceding embodiment, wherein the second housing includes a second engagement structure including a fourth protrusion, a fifth protrusion, and a sixth protrusion extending from a second side of the second housing; and the cover includes a first channel configured to at least partially receive the first protrusion in the first configuration and to at least partially receive the fifth protrusion in the second configuration.

The electrical connector of any preceding embodiment, wherein the second housing includes a first recess or aperture configured to engage the third protrusion in the first configuration and to engage the sixth protrusion in the second configuration.

The electrical connector of any preceding embodiment, wherein the third protrusion is configured to snap into the first recess or aperture to lock the cover with the second housing.

The electrical connector of any preceding embodiment, wherein the second housing includes a second channel and a second recess or aperture; the second channel is configured to at least partially receive the fourth protrusion in the first configuration and to at least partially receive the second protrusion in the second configuration; and the second recess or aperture is configured to engage the sixth protrusion in the first configuration and to engage the third protrusion in the second configuration.

The electrical connector of any preceding embodiment, wherein the second housing includes a front, a rear, and a plurality of sides extending between the front and the rear; the front face the first housing; the rear faces away from the first housing; in the first configuration, an inner surface of the cover is in contact with a first side of the plurality of sides of the second housing; and in the second configuration, the inner surface of the cover is in contact with the rear of the second housing.

The electrical connector of any preceding embodiment, wherein, in the first configuration, the inner surface is parallel with a connection direction; and in the second configuration, the inner surface is perpendicular to the connection direction.

The electrical connector of any preceding embodiment, wherein, in the first configuration, the cover is disposed in a first orientation; in the second configuration, the cover is disposed in a second orientation; and the second orientation is rotated 180 degrees about a first axis and 90 degrees about a second axis relative to the first orientation.

The electrical connector of any preceding embodiment, wherein the first axis is parallel with a connection direction and the second axis is perpendicular to the second axis.

An electrical assembly, comprising: the electrical connector of any preceding embodiment; the first terminal disposed at least partially in the first housing and coupled to a first wire; and the second terminal coupled to a second wire and disposed at least partially in the second housing and the cover.

The electrical assembly of any preceding embodiment, further comprising a third terminal coupled to a third wire and disposed at least partially in the first housing; and a fourth terminal coupled to a fourth wire, disposed at least partially in the second housing and the cover, and electrically connected to the third terminal.

The electrical assembly of any preceding embodiment, wherein the first terminal extends parallel to a connection direction; and at least a portion of the first wire extends parallel to the connection direction.

The electrical assembly of any preceding embodiment, wherein the second terminal extends parallel to the connection direction; and at least a portion of the second wire extends parallel to the connection direction.

The electrical assembly of any preceding embodiment, wherein the second terminal includes a right-angle configuration; and at least a portion of the second wire extends perpendicular to the connection direction.

A method of assembling the electrical assembly of any preceding embodiment, the method comprising connecting the cover with the second housing in a first configuration or a second configuration, and connecting the first housing with the second housing.

A wiring harness comprising the electrical assembly of any preceding embodiment.

A vehicle comprising the electrical assembly of any preceding embodiment.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. An electrical connector, comprising:
a first housing configured to at least partially receive a first terminal;
a second housing configured to at least partially receive a second terminal and configured for coupling with the first housing; and
a cover configured for connection with the second housing in a first configuration and a second configuration.

2. The electrical connector of claim 1, wherein the first configuration is a straight configuration, and the second configuration is a right-angle configuration.

3. The electrical connector of claim 1, wherein the second housing includes an engagement structure comprising a first protrusion, a second protrusion, and a third protrusion extending from a side of the second housing.

4. The electrical connector of claim 3, wherein the cover is configured to engage the first protrusion and the third protrusion in the first configuration and to engage the second protrusion and the third protrusion in the second configuration.

5. The electrical connector of claim 4, wherein the first protrusion comprises a first rib that is parallel to a connection direction;
the second protrusion comprises a second rib that is perpendicular to the first rib; and
the third protrusion comprises a ramp.

6. The electrical connector of claim 5, wherein the ramp comprises a pair of trapezoidal perpendicular faces and a pair of trapezoidal ramped faces.

7. The electrical connector of claim 4, wherein the first protrusion, the second protrusion, and the third protrusion are spaced from each other such that the first protrusion, the second protrusion, and the third protrusion do not overlap in a connection direction of the electrical connector.

8. The electrical connector of claim 4, wherein the second housing includes a second engagement structure including a fourth protrusion, a fifth protrusion, and a sixth protrusion extending from a second side of the second housing; and
the cover includes a first channel configured to at least partially receive the first protrusion in the first configuration and to at least partially receive the fifth protrusion in the second configuration.

9. The electrical connector of claim 8, wherein the second housing includes a first recess or aperture configured to engage the third protrusion in the first configuration and to engage the sixth protrusion in the second configuration.

10. The electrical connector of claim 9, wherein the third protrusion is configured to snap into the first recess or aperture to lock the cover with the second housing.

11. The electrical connector of claim 9, wherein the second housing includes a second channel and a second recess or aperture;
the second channel is configured to at least partially receive the fourth protrusion in the first configuration and to at least partially receive the second protrusion in the second configuration; and
the second recess or aperture is configured to engage the sixth protrusion in the first configuration and to engage the third protrusion in the second configuration.

12. The electrical connector of claim 1, wherein the second housing includes a front, a rear, and a plurality of sides extending between the front and the rear;
the front face the first housing;
the rear faces away from the first housing;
in the first configuration, an inner surface of the cover is in contact with a first side of the plurality of sides of the second housing; and
in the second configuration, the inner surface of the cover is in contact with the rear of the second housing.

13. The electrical connector of claim 12, wherein, in the first configuration, the inner surface is parallel with a connection direction; and
in the second configuration, the inner surface is perpendicular to the connection direction.

14. The electrical connector of claim 1, wherein, in the first configuration, the cover is disposed in a first orientation;
in the second configuration, the cover is disposed in a second orientation; and
the second orientation is rotated 180 degrees about a first axis and 90 degrees about a second axis relative to the first orientation.

15. The electrical connector of claim 14, wherein the first axis is parallel with a connection direction and the second axis is perpendicular to the second axis.

16. An electrical assembly, comprising:
the electrical connector of claim 1;
the first terminal disposed at least partially in the first housing and coupled to a first wire; and
the second terminal coupled to a second wire and disposed at least partially in the second housing and the cover.

17. The electrical assembly of claim 16, further comprising a third terminal coupled to a third wire and disposed at least partially in the first housing; and
a fourth terminal coupled to a fourth wire, disposed at least partially in the second housing and the cover, and electrically connected to the third terminal.

18. The electrical assembly of claim 16, wherein the first terminal extends parallel to a connection direction; and
at least a portion of the first wire extends parallel to the connection direction.

19. The electrical assembly of claim 18, wherein the second terminal extends parallel to the connection direction; and
at least a portion of the second wire extends parallel to the connection direction.

20. The electrical assembly of claim 18, wherein the second terminal includes a right-angle configuration; and
at least a portion of the second wire extends perpendicular to the connection direction.
